(19) United States
(12) Patent Application Publication
(10) Pub. No.: US 2014/0126627 A1
(43) Pub. Date: May 8, 2014

(54) SEARCH APPARATUS AND SEARCH METHOD OF PREDICTION MODE HAVING DIRECTION

(71) Applicant: INDUSTRIAL TECHNOLOGY RESEARCH INSTITUTE, Hsinchu (TW)

(72) Inventors: Ce-Min Fang, Tainan City (TW); Wen-Hao Chung, New Taipei City (TW)

(73) Assignee: INDUSTRIAL TECHNOLOGY RESEARCH INSTITUTE, Hsinchu (TW)

(21) Appl. No.: 13/776,728

(22) Filed: Feb. 26, 2013

(30) Foreign Application Priority Data
Nov. 2, 2012 (TW) 101140750

(51) Int. Cl. H04N 7/26

(52) U.S. Cl. CPC H04N 19/00018
USPC 375/240.02

(57) ABSTRACT

A search apparatus and search method of prediction mode having direction are provided. The apparatus and method can be applied to intra-prediction of video processing. An initial prediction mode is quickly selected based on a distribution of directional energy values. A plurality of first-stage prediction modes are obtained by spreading out from the initial prediction mode. A fine adjustment is processed according to the prediction mode of a neighboring block. The coding costs of the first-stage prediction modes are calculated and then the prediction mode with the lowest coding cost is selected. Therefore, a total calculation amount is reduced.

### CROSS-REFERENCE TO RELATED APPLICATION

This application claims the priority benefit of Taiwan application serial no. 101140750, filed on Nov. 2, 2012. The entirety of the above-mentioned patent application is hereby incorporated by reference herein and made a part of this specification.

### BACKGROUND

1. Technical Field

The disclosure relates to a video image processing technique.

2. Related Art

H.264 is a video compression standard developed by a joint video team commonly constituted by a video coding expert group (VCEG) and a moving pictures experts group (MPEG). The H.264 uses pixels reconstructed through intra frame coding and inter frame coding to predict internal coding blocks, and therefore a spatial and temporal prediction may be efficiently performed. When an intra prediction technique is used in pixel prediction, in order to enhance a coding efficiency, the H.264 performs the prediction by using correlation with neighboring blocks on a spatial domain and only records a used prediction mode and an actual error when storing data. Since a value of such error is less than an original pixel value and an amount of encoded data is also relatively less, a bit rate of the encoding may be effectively reduced.

The aforementioned neighboring blocks generally refer to blocks located to the left, the top left, the top and the top right of a current encoded block, and pixels of the neighboring blocks have been encoded and reconstructed so that information recorded therein can be reused. Taking prediction of a 4×4 block as an example, FIG. 1 illustrates a 4×4 block of a conventional H.264, wherein a-p represent pixels of the current block and A-M represent the neighboring pixels, and wherein A-H represent the neighboring pixels located on the top and to the top right of the block, I-L represent the neighboring pixels located to the left of the block, and M represents the neighboring pixel located to the top left of the block. The prediction mode of the intra prediction of H.264 is to use pixel values of the neighboring pixels to perform the prediction.

FIG. 2 is a schematic diagram of 9 prediction modes of the intra prediction modes of the 4×4 block of a conventional H.264. The 9 prediction modes of the intra prediction of in the H.264 includes a mode 0 (a vertical prediction mode), a mode 1 (a horizontal prediction mode), a mode 2 (a direct current (DC) prediction mode), a mode 3 (a diagonal down left prediction mode), a mode 4 (a diagonal down right prediction mode), a mode 5 (a vertical right prediction mode), a mode 6 (a horizontal down prediction mode), a mode 7 (a vertical left prediction mode) and a mode 8 (a horizontal up prediction mode).

Along with rapid development of technology, a size of a display device becomes larger, and resolution of video played thereon is also increased. However, since bandwidth is limited, in order to transmit and store video content with a high resolution, the widely used video compression standard H.264 has been gradually unable to satisfy such demands. In terms of the intra prediction, the 9 prediction modes of the H.264 are increased to 35 prediction modes of a high efficiency video coding (HEVC), shown as FIG. 3, which is a schematic diagram of the 35 prediction modes used by the HEVC. If a prediction mode with the lowest coding cost is to be found from the 35 prediction modes of the HEVC, a calculation amount thereof is far greater than a calculation amount of searching from the 9 prediction modes of the H.264. However, considering factors such as hardware cost, a size of a prediction unit has to be flexible, and different sizes of the prediction units are required to perform extremely complicated coding cost calculations on various prediction modes. Therefore, it is required to develop a faster way to find the most suitable prediction mode, so as to reduce time required for the calculation.

### SUMMARY

The disclosure provides a search method performed in a search apparatus of prediction mode having direction. In the search method, a plurality of directional energy values of a plurality of directions are obtained specific to a block of a frame in a video. At least one initial prediction mode is selected based on a distribution of the directional energy values, and a plurality of first-stage prediction modes are obtained by spreading out from the initial prediction mode. Coding costs of the first-stage prediction modes are calculated and a prediction mode with the lowest coding cost is selected.

The disclosure provides another a search method performed in a search apparatus of prediction mode having direction, and the search method includes following steps. A plurality of directional energy values of a plurality of directions are obtained specific to a block of a frame in a video. At least one initial prediction mode is selected according to the directional energy values, and a plurality of first-stage prediction modes are obtained by spreading out from the initial prediction mode. The first-stage prediction modes are adjusted with reference of a prediction mode searched from a neighboring block of the block. Coding costs of the first-stage prediction modes are calculated, and a prediction mode with the lowest coding cost is selected.

The disclosure provides a search apparatus of prediction mode having direction, wherein the search apparatus includes a directional energy calculator, an analyzer, a selector, a spreader and a coding cost calculator. The directional energy calculator obtains a plurality of directional energy values of a plurality of directions specific to a block of a frame in a video. The analyzer analyzes a distribution of the directional energy values for classification. The selector coupled to the analyzer selects an initial prediction mode according to a classification result from the analyzer. The spreader obtains a plurality of first-stage prediction modes by spreading out from the initial prediction mode. The coding cost calculator calculates coding costs of the first-stage prediction modes and selects a prediction mode with the lowest coding cost.

The disclosure provides another search apparatus of prediction mode having direction, wherein the search apparatus includes a directional energy calculator, an initial prediction mode selector, a spreader, an adjustor and a coding cost calculator. The directional energy calculator obtains a plurality of directional energy values of a plurality of directions specific to a block of a frame in a video. The initial prediction mode selector selects at least one initial prediction mode according to the directional energy values. The spreader obtains a plurality of first-stage prediction modes by spreading out from the initial prediction mode. The adjustor adjusts the first-stage prediction modes with reference of a prediction mode searched from a neighboring block of the block. The coding cost calculator calculates coding costs of the first-stage prediction modes and selects a prediction mode with the lowest coding cost.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a 4×4 block of a conventional H.264.

FIG. 2 is a schematic diagram of 9 prediction modes of intra prediction modes of the 4×4 block of a conventional H.264.

FIG. 3 is a schematic diagram of 35 prediction modes used by a high efficiency video coding (HEVC).

FIG. 4 is a block diagram of an intra prediction unit according to an embodiment of the disclosure.

FIG. 5 is a flowchart illustrating an intra prediction method according to an embodiment of the disclosure.

FIG. 6 is a schematic diagram illustrating a selection and a spread direction of an initial prediction mode when a distribution of directional energy values is a first distribution.

FIG. 7 is a schematic diagram of a selection and spread direction of an initial prediction mode when a distribution of directional energy values is a third distribution.

FIG. 8 is a schematic diagram of obtaining directions of a plurality of first-stage prediction modes by spreading out from the initial prediction mode.

FIG. 9 is a schematic diagram of adjusting directions of first-stage prediction modes when a direction of a prediction mode of the neighboring block is not within a coverage range.

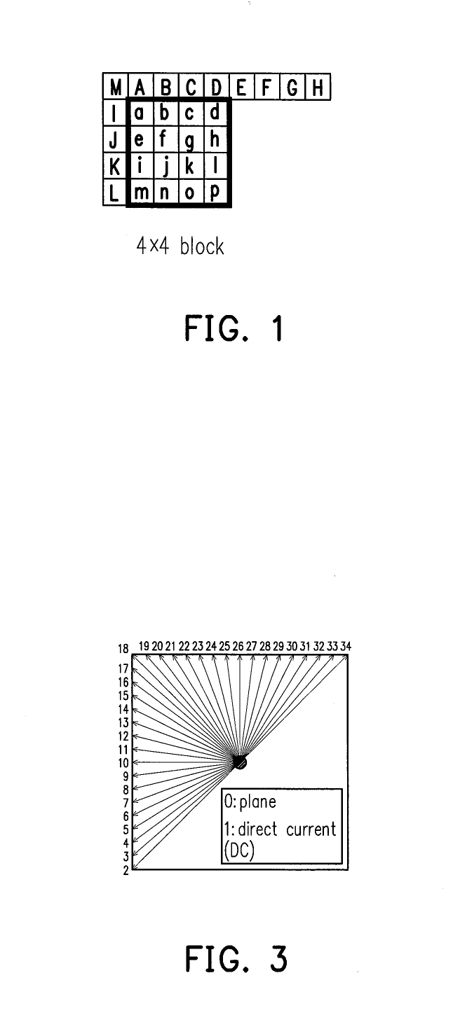

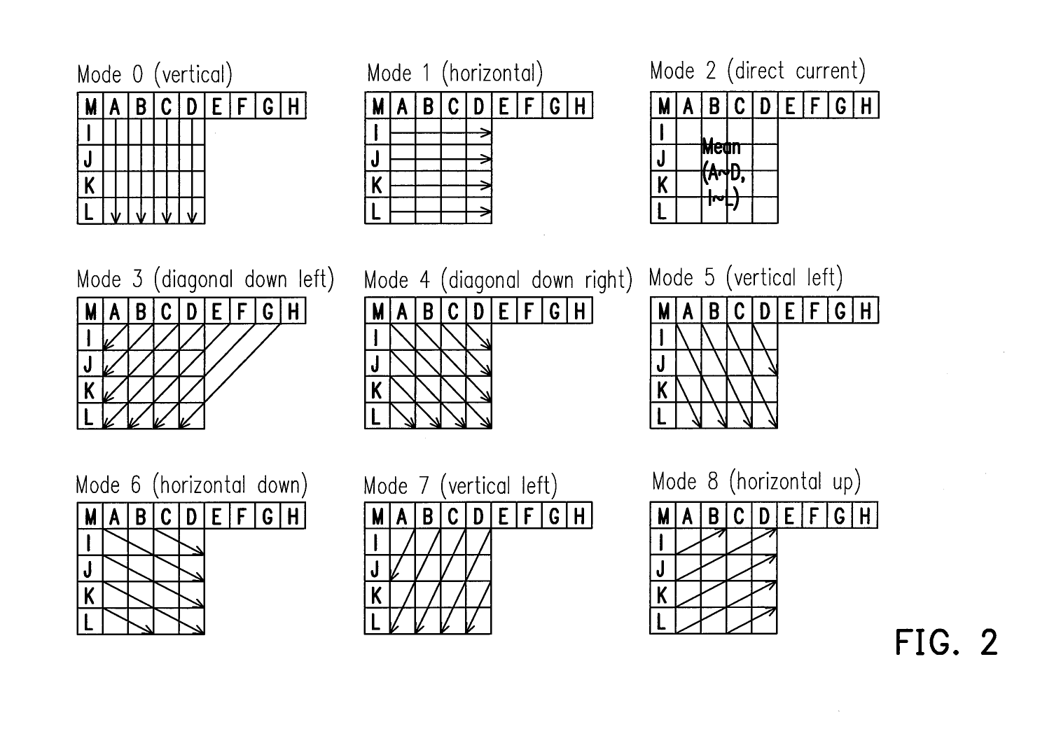

### DETAILED DESCRIPTION OF DISCLOSED EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts. Theses exemplary embodiments are only a part of the disclosure, and the disclosure does not disclose all of the implementations. More precisely, these exemplary embodiments are only examples of the system and method in the claims of the disclosure.

When an intra prediction in video image processing is performed, each prediction mode requires to estimate a coding size and calculate a coding cost. However, a large number of the prediction modes may cause a large amount of calculation on the coding cost. Therefore, an effective search method is required to reduce the calculation amount and further reduce time required for the calculation. However, the reduced part of calculation inevitably influences a coding performance since a complete coding cost calculation of all of the prediction modes is not actually performed, and the selection of the overall best prediction mode is not guaranteed. The search method provided by the disclosure may still maintain a coding performance similar to that of the complete calculation while the calculation amount is reduced.

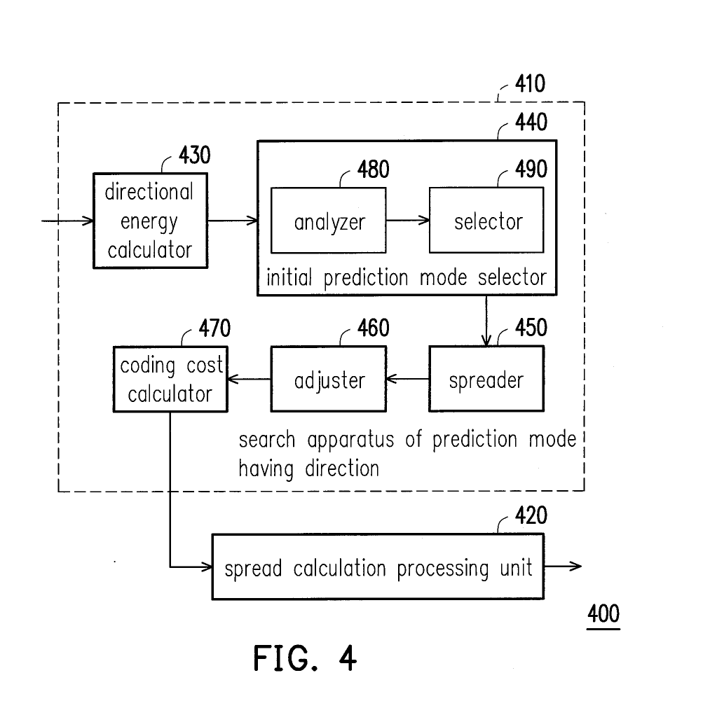

FIG. 4 is a block diagram of an intra prediction unit according to an embodiment of the disclosure, which is merely described as an example but not intended to limit the disclosure. Referring to FIG. 4, the intra prediction unit 400 includes a search apparatus 410 of prediction mode having direction and a spread calculation processing unit 420. The search apparatus 410 of prediction mode having direction includes a directional energy calculator 430, an initial prediction mode selector 440, a spreader 450, an adjustor 460 and a coding cost calculator 470. Although the search apparatus 410 of prediction mode having direction of the present embodiment is composed of the above different components, all of the components or a part of the components can be implemented into a single hardware device. Further, the whole intra frame prediction unit 400 can be implemented into a single hardware device.

First, the aforementioned components are briefly introduced, and detailed content is disclosed in collaboration with a flowchart of an intra prediction method. The directional energy calculator 430 obtains a plurality of directional energy values of a plurality of directions specific to a block to be processed in a frame of a video. The initial prediction mode selector 440 selects at least one initial prediction mode according to the directional energy values; while in another method, the initial prediction mode selector 440 may select the at least one initial prediction mode based on a distribution of the directional energy values. Therefore, the initial prediction mode selector 440 may include an analyzer 480 and a selector 490. The analyzer 480 analyzes the distribution of the directional energy values for classification. The selector 490 coupled to the analyzer 480 selects the initial prediction mode according to a classification result from the analyzer 480. In one embodiment, the search apparatus 410 of prediction mode having direction further includes at least one processor to perform the spread calculation processing unit 420, the directional energy calculator 430, the spreader 450, the adjuster 460, the coding cost calculator 470, the analyzer 480 and/or the selector 490 for the purpose mentioned above, but is not limited thereto. In another embodiment, the individual component of the ultra prediction unit 400 (i.e. the directional energy calculator 430, the spreader 450, the adjuster 460, the coding cost calculator 470, the analyzer 480 and/or the selector 490) is/are implemented by dedicated hardware having the corresponding circuits. The spreader 450 obtains a plurality of first-stage prediction modes by spreading out from the initial prediction mode. The adjustor 460 adjusts the first-stage prediction modes with reference of a prediction mode searched from a neighboring block of the block. In the present embodiment, the adjustor 460 is included, though the present disclosure is not limited thereto; while in another embodiment, the adjustor 460 may be omitted. The coding cost calculator 470 calculates coding costs of the first-stage prediction modes, and selects a prediction mode with the lowest coding cost. The spread calculation processing unit 420 selects a plurality of second-stage prediction modes by spreading out from the prediction mode selected by the coding cost calculator 470 and calculates coding costs of the second-stage prediction modes to select a prediction mode with the lowest coding cost, and then the selected prediction mode is used to perform the intra prediction.

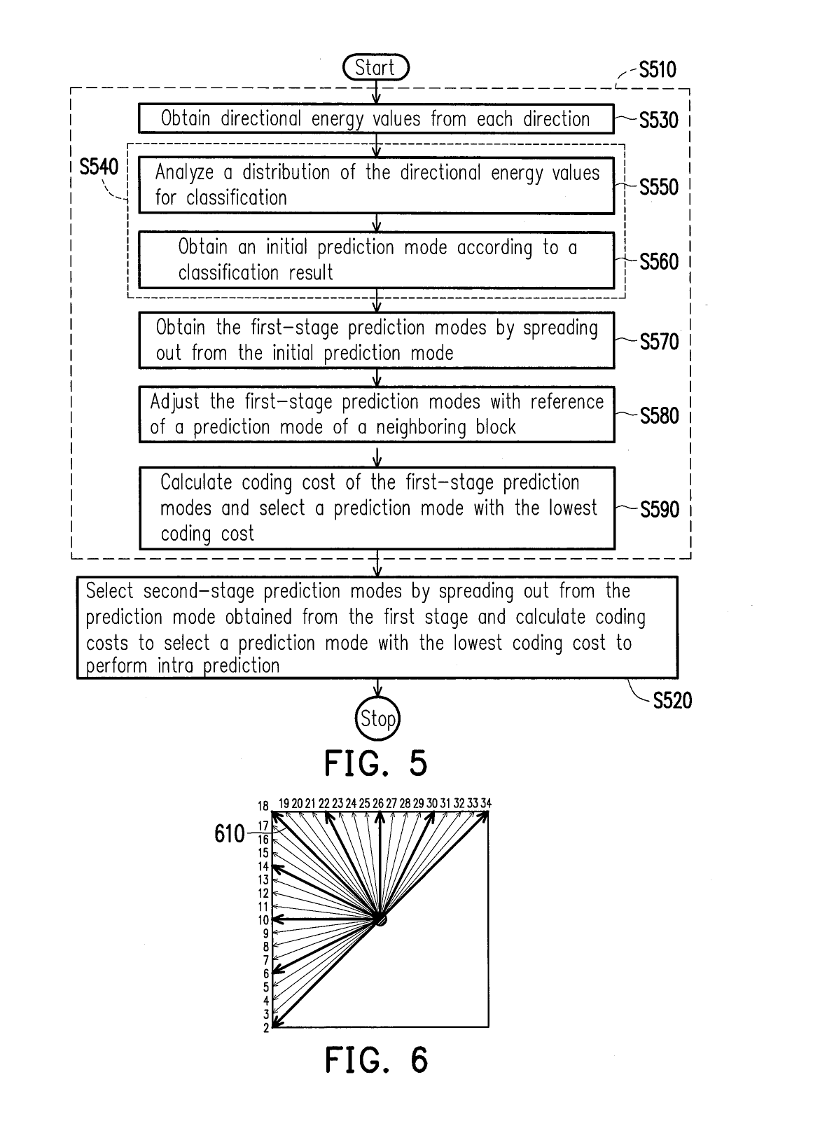

FIG. 5 is a flowchart illustrating an intra prediction method according to an embodiment of the present disclosure, which is merely described as an example but not intended to limit the present disclosure. Referring to FIG. 4 and FIG. 5, the intra prediction method of the present embodiment is approximately divided into two stages, which are respectively the step S510 and the step S520. The step S510 of the first stage is a search method of prediction mode having direction (which is also referred to as an angle type prediction mode), by which a prediction mode with the lowest coding cost in the prediction modes of the first stage is searched specific to the prediction modes having direction, and the step S510 may be realized by the search apparatus 410 of prediction mode having direction. The step S520 is to select a plurality of second stage prediction modes by spreading out from the prediction mode selected in the first stage. For example, the prediction mode with the lowest cost and direction searched in the first stage is taken as a center and spreads out with additions of a right and a left neighboring prediction modes, and prediction modes not having direction (which is also referred to as none angle type prediction mode) are also added, which are generally a direct current (DC) mode and a planar mode, to perform the coding cost calculation of the second stage. Finally, a prediction mode with the lowest coding cost is selected from the prediction mode with the lowest coding cost in the first stage and the added prediction modes of the second stage, and then the selected prediction mode is used to perform the intra prediction of the block and subsequent coding, etc. The step S520 is mainly realized by the spread calculation processing unit 420.

In step S530, the directional energy calculator 430 obtains a plurality of directional energy values of a plurality of directions specific to a block to be processed in a frame of a video. The so-called directional energy value of a certain direction refers to that when the directional energy value is the minimum, a pixel value variation of the aforementioned block along such direction is the minimum. In other words, prediction performed along such direction is the most efficient. However, the disclosure is not limited thereto, and the maximum directional energy value can also be used to represent the minimum pixel value variation of the aforementioned block along such direction. In the present embodiment, the plurality of directions are, for example, four directions. For example, the directional energy values of the four direction of horizontal, vertical, 45 degrees and 135 degrees are calculated, and in such case, the directional energy calculator 430 obtains the directional energy values of the four directions by using a direction detecting method.

In step S540, the initial prediction mode selector 440 selects at least one initial prediction mode according to the directional energy values such as selecting a prediction mode of the direction with the minimum directional energy value to serve as a candidate initial prediction mode, or selecting prediction modes of the first three directions with the minimum directional energy value to serve as candidate initial prediction modes. However, the disclosure is not limited thereto, and in another method, the initial prediction mode selector 440 may select the at least one initial prediction mode according to a distribution of the directional energy values, for example, the step S540 includes the step S550 and the step S560.

In the step S550, the analyzer 480 analyzes the distribution of the directional energy values for classification. When differences among the directional energy values in all of the directions are less than a first threshold, the distribution of the directional energy values is classified as a first distribution. In other words, the distribution of the directional energy values is classified as the first distribution when the directional energy values are all less than or greater than a certain threshold. In the case of the first distribution, energy distribution of all of the directions are close to each other, i.e. the directional energy values are either all very large or very small, and there is no particularly prominent directional energy value. When differences between one of the directional energy values (i.e. a directional energy value corresponding to the first direction) and the remaining directional energy values are all greater than a second threshold, and a relationship between the directional energy value corresponding to the first direction and the remaining directional energy values indicates that a pixel value variation along the first direction in the block is smaller than pixel value variations along the directions corresponding to the remaining directional energy values in the block, the distribution of the directional energy values is classified as a second distribution. When a difference between two of the directional energy values (i.e. two directional energy values corresponding to a second direction and a third direction) is smaller than a third threshold, and differences between each of the above two directional energy values and the other remaining directional energy values are all greater than a fourth threshold, and a relationship between the directional energy values corresponding to the second direction and the third direction and the remaining directional energy values indicates that pixel value variations along the second direction and the third direction in the block are smaller than pixel value variations along the directions corresponding to the remaining directional energy values in the block, the distribution of the directional energy values is classified as a third distribution. When differences among three of the directional energy values (i.e. three directional energy values corresponding to a fourth direction, a fifth direction and a sixth direction) are all less than a fifth threshold, and differences between each of the above three directional energy values and the other remaining directional energy values are all greater than a sixth threshold, and a relationship between the directional energy values corresponding to the fourth direction, the fifth direction and the sixth direction and the remaining directional energy values indicates that pixel value variations along the fourth direction, the fifth direction and the sixth direction in the block are less than pixel value variations along the directions corresponding to the remaining directional energy values in the block, the distribution of the directional energy values is classified as a fourth distribution.

In step S560, the selector 490 selects the initial prediction mode according to a classification result from the analyzer 480. FIG. 6 is a schematic diagram illustrating selection and a spread direction of the initial prediction mode when the distribution of the directional energy values is the first distribution, which is only as an example, and is not used to limit the disclosure. Referring to FIG. 6, when the distribution of the directional energy values is the first distribution, since the directional energy values of all of the directions are close to each other, it is probably difficult to find a suitable angle type prediction mode. Hence, a prediction mode of the central direction in all of the prediction modes having direction is selected as the initial prediction mode such as a prediction mode of an upper left 45 degrees direction 610, and spaces are widened during spreading in the first stage, so that a spread range thereof may cover all of the angle type prediction modes as possible. When the distribution of the directional energy values is classified as the second distribution, since the directional energy value of the first direction is less than that of the other directions and differences therebetween are obvious, the prediction mode of the first direction is directly selected as the initial prediction mode, and a general spreading method is used to select the first-stage prediction modes.

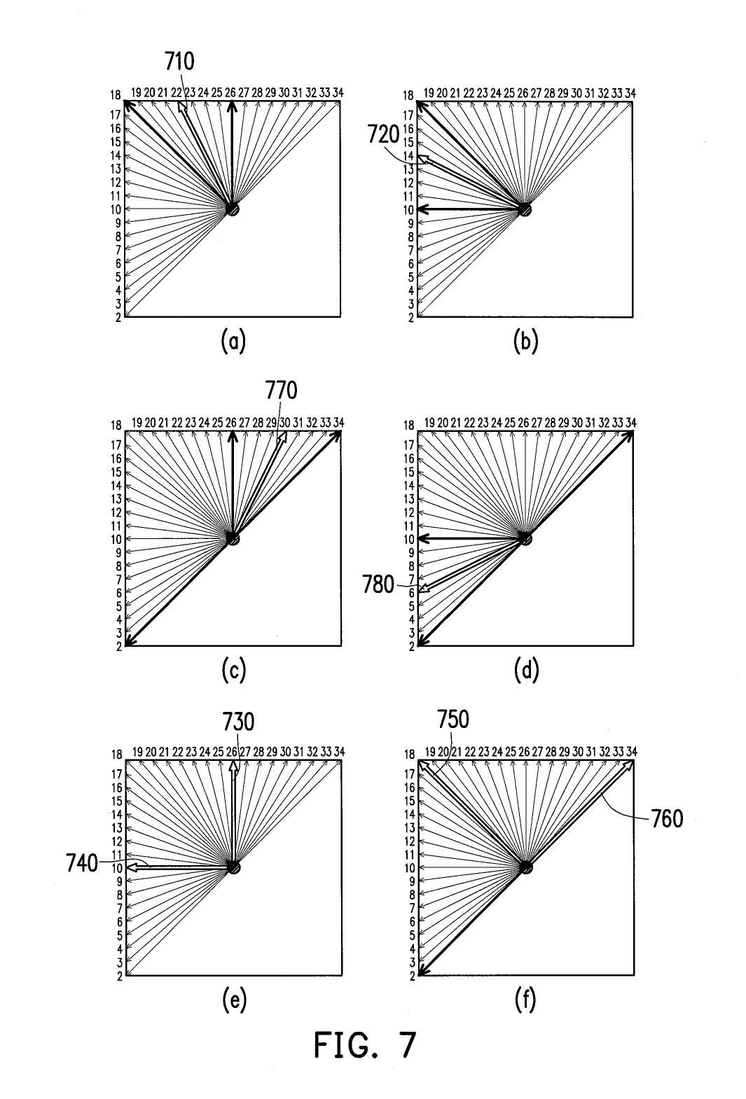

FIG. 7 is a schematic diagram of selection and spread direction of the initial prediction mode when the distribution of the directional energy values is the third distribution, which is only as an example, and is not used to limit the disclosure. When the distribution of the directional energy values is classified as the third distribution, the directional energy values of the second direction and the third direction are less than that of the other directions, and differences therebetween are relatively large, and a direction in the center of a smaller one of the included angles between the two directions is taken as the initial prediction direction. The details are described as follows. Referring to (a) and (b) of FIG. 7, when the angle between the second direction and the third direction is less than 90 degrees, prediction modes of central directions 710 and 720 between the second direction and the third direction are selected as the initial prediction mode. When the central direction between the second direction and the third direction is one of the directions corresponding to the directional energy values originally obtained by the directional energy calculator 430, in the case of the third distribution, the directional energy values of the second direction and the third direction represent that the pixel value variations along the second direction and the third direction are the minimum, and the directional energy values of the remaining directions represent that the pixel value variations along the remaining directions are relatively large (poor), and now a dual initial mode is used. Referring to (e) and (f) of FIG. 7, in the case that the directional energy calculator 430 only obtains the directional energy values of four directions, when an angle between the second direction and the third direction is equal to 90 degrees, a central direction of the two directions is happen to be a direction with a poor directional energy value of the other two directions. If the central directions are selected as initial prediction directions, it is apparently unreasonable. Therefore, the two directions having better directional energy values are all selected as the initial prediction directions. For example, in (e) of FIG. 7, the prediction modes of a second direction 730 and a third direction 740 are selected as the initial prediction modes, and in (f) of FIG. 7, the prediction modes of a second direction 750 and a third direction 760 are selected as the initial prediction modes. In other words, when the central direction of the second direction and the third direction are directions with known poor directional energy values, the prediction modes of both the second direction and the third direction are used as the initial prediction modes. However, in order to effectively decrease a calculation amount, in the dual initial mode, amplitude of spreading to select the prediction modes in the first stage is only a half of the general ones, so as to maintain an original calculation amount. Referring to (c) and (d) of FIG. 7, when the angle between the second direction and the third direction is greater than 90 degrees, one of the second direction and the third direction is reversed by 180 degrees to serve as a seventh direction, and a central direction 770 or 780 between the seventh direction and another one of the second direction and the third direction that is not reversed by 180 degrees fall within a range of the prediction modes, and the prediction mode of the central direction is selected as the initial prediction mode, which can be represented by the following equations:

M_{X}=(M_{A}+M_{B})/2

If a difference between M_{A} and M_{B} is greater than 16:

if (M_{A}+M_{B})/2>18

M_{X}=((M_{A}+M_{B})/2)+16

else

M_{X}=((M_{A}+M_{B})/2)+16

wherein M={2-34} are reference numbers of directions of the prediction modes having direction in high efficiency video coding (HEVC), which are sequentially increased from the lower left to the upper right. M_{A} is the second direction, M_{B} is the third direction, M_{X} is the direction of the initial prediction mode, and plus and minus 16 in the equations refers to rotation of 90 degrees.

Another complicated method of defining a central direction of two directions is described as follows. Each direction of the actual prediction mode of the HEVC is denoted as Mᵢ, wherein {Mᵢ|i=2˜34}. (Mᵢ−M_{A})²+(Mᵢ−M_{B})² is calculated and the minimum value of Mᵢ may be obtained. When |Mᵢ−M_{A}| or |Mᵢ−M_{B}| is greater than 16, (32−|Mᵢ−M_{A}|)² or (32−|Mᵢ−M_{B}|)² is calculated instead. Assume that M_{X}=Mᵢ is the direction of the initial prediction mode. When M_{X} is one of the directions detected by the directional energy calculator 430, the dual initial mode is used.

When the distribution of the directional energy value is classified as the fourth distribution, the prediction mode of a central direction of the fourth direction, the fifth direction and the sixth direction is selected as the initial prediction mode, which is represented by the following equation:

M_{X}=(M_{A}+M_{B}+M_{C})/3

When the above equation is applied, some corrections are required before calculation, i.e. a difference between each two of M_{A}, M_{B} and M_{C} is set to not being greater than 16, wherein the difference 16 is 90 degrees, and M is adjusted to be M−32 or M+32 (rotated by 180 degrees) according to an actual requirement. In such way, it ensures that the angle of the three directions is a small angle but not a large angle, and then the three directions are summed and divided by 3. In the above equation, M={2-34} are reference numbers of directions of the prediction modes having direction in HEVC, which are sequentially increased from the lower left to the upper right, M_{A} is the fourth direction, M_{B} is the fifth direction, M_{C} is the sixth direction, and M_{X} is the direction of the initial prediction mode.

Another complicated method of defining a central direction of the fourth direction, the fifth direction and the sixth direction is described as follows. Each direction of the actual prediction mode of the HEVC is denoted as wherein {Mᵢ|i=2˜34}. (Mᵢ−M_{A})²+(Mᵢ−M_{B})²+(Mᵢ−M_{C})² is calculated and the minimum value of Mᵢ may be obtained. When |Mᵢ−M_{A}| or |Mᵢ−M_{B}| or |Mᵢ−M_{C}| is greater than 16, (32−|Mᵢ−M_{A}|)² or (32−|Mᵢ−M_{B}|)² or (32−|Mᵢ−M_{C}|)² is calculated instead. Assume that M_{X}=Mᵢ is the direction of the initial prediction mode. When M_{X} is one of the directions detected by the directional energy calculator 430, none special processing is performed.

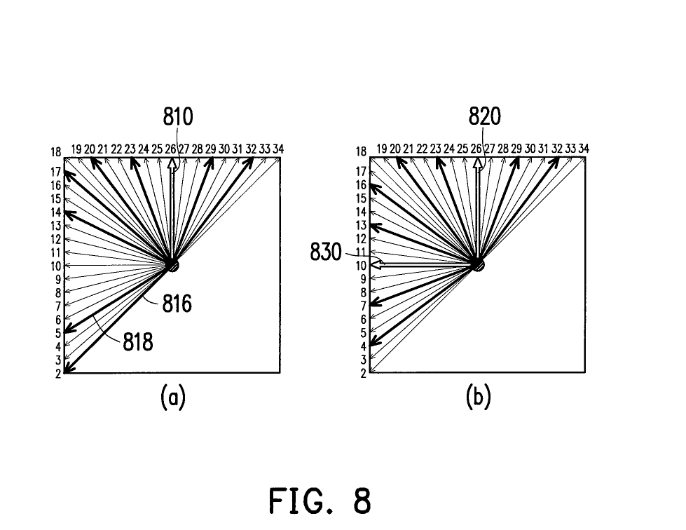

In step S570, the spreader 450 obtains a plurality of first-stage prediction modes by spreading from the initial prediction mode. In the related descriptions of the step S560, spreading of the initial prediction mode is mentioned and will be re-described as follows. FIG. 8 is a schematic diagram of obtaining directions of a plurality of first-stage prediction modes by spreading from the initial prediction mode, which is only as an example and is not used to limit the disclosure. Referring (a) of FIG. 8, when the number of the initial prediction mode is only one, a direction 810 of the initial prediction mode is taken as a center and spreads out towards the left and right in a same predetermined space to select prediction modes of N directions to serve as the first-stage prediction modes, wherein N is a positive integer greater than 1. For example, two prediction modes next to each other are consistently selected, and each of the two prediction modes respectively selects prediction modes of four directions. Moreover, in an addition of the initial prediction mode, nine prediction modes are taken as the first-stage prediction modes in total. Referring to (b) of FIG. 8, when the number of the initial prediction modes is two, i.e. the dual initial prediction mode, directions 820 and 830 of the two initial prediction modes are taken as centers, and are spread out towards the left and right with predetermined spaces to select prediction modes of N/2 directions. For example, two prediction modes next to each other are consistently selected, and each of the two prediction modes of 2 directions respectively selects prediction modes of two directions to serve as the first-stage prediction modes. When a spread direction exceeds a range of directions of all of the prediction modes, the spread direction have to be turned over by 180 degrees for spreading, for example, directions 816 and 818 in (a) of FIG. 8.

In step S580, the adjustor 460 adjusts the first-stage prediction modes with reference of a prediction mode searched from a neighboring block of the block. In the first stage, since the prediction modes having direction are subject to the coding cost calculation and searching, when the prediction mode searched from the neighboring block is a prediction mode not having direction, no adjustment is performed, i.e. the first-stage prediction modes are not changed. When a direction of the prediction mode searched from the neighboring block is within a coverage range formed by taking the direction of the initial prediction mode as a center for spreading, no adjustment is performed. Namely, when the prediction mode of the neighboring block falls within a spread selection range of the first-stage prediction modes, if the prediction mode of the neighboring block is truly the best prediction mode, it is expected to be also selected in following calculation and selection, so that the first prediction modes are not changed.

When the direction of the prediction mode searched from the neighboring block is not within the aforementioned coverage range, the prediction mode of the neighboring block is added to the first-stage prediction modes, and a prediction mode with a low probability to become the best prediction mode is removed, namely, the prediction mode searched from the neighboring block is used to replace the prediction mode located at a boundary of the coverage range and having the farthest distance. It should be noticed that since the direction of the prediction mode having direction is a ring model rather than a linear model, i.e. the prediction mode (with a reference number 34) of the upper right 45 degrees and the prediction mode (with a reference number 2) of the lower left 45 degrees are regarded as neighboring prediction modes. Therefore, when the farthest prediction mode is to be determined, the ring model has to be considered rather than the linear model.

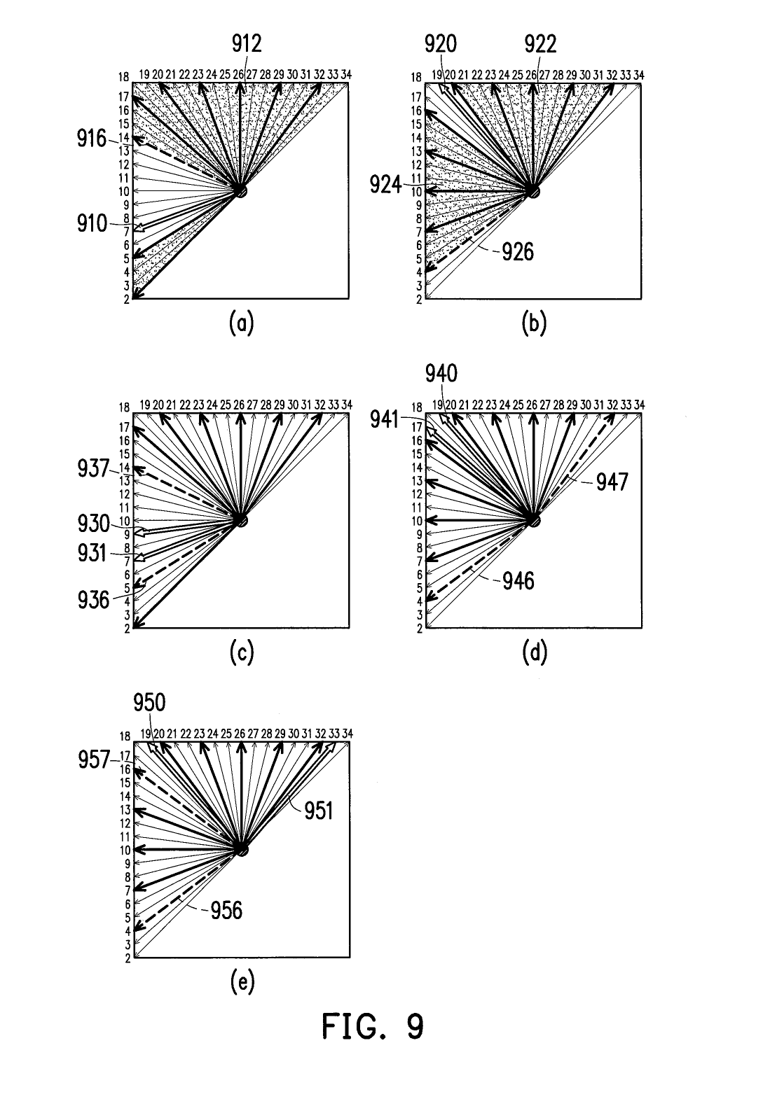

FIG. 9 is a schematic diagram of adjusting directions of the first-stage prediction modes when the direction of the prediction mode searched from the neighboring block is not within the coverage range, which is only as an example, and is not used to limit the disclosure. Referring (a) of FIG. 9, a direction 910 of the prediction mode searched from the neighboring block is not within a coverage range 912 from which the first-stage prediction modes are selected, and a direction 916 of the prediction mode located at the boundary of the coverage range and having the farthest distance is removed. Referring to (b) of FIG. 9, due to the dual initial mode, the first-stage prediction modes have two coverage ranges 922 and 924, and the prediction mode of the neighboring block (direction 920) is used to replace the prediction mode (direction 926) located at the boundary of the coverage range and having the farthest distance.

When directions of prediction modes of two neighboring blocks are all out of the coverage range, there are three possibilities as follows. In the first possibility, when the number of the initial prediction mode is only one, the prediction modes of two boundaries of the coverage range are replaced by the prediction modes of two neighboring blocks. Referring to (c) of FIG. 9, the prediction modes (directions 930 and 931) of the neighboring blocks are used to replace the prediction mode (directions 936 and 937) located at the boundaries of the coverage range and having the farthest distance. In the second possibility, in the case of the dual initial mode, when directions of the prediction modes of two neighboring blocks all fall in a same one of two sections outside the coverage range, the prediction modes on the two boundaries with the farthest distance from the section are replaced by the prediction modes of the two neighbouring blocks. Referring to (d) of FIG. 9, the prediction modes (directions 940 and 941) of the neighboring blocks are used to replace the prediction modes (directions 946 and 947) located at the boundaries of the coverage range and having the farthest distance. In the third possibility, in the case of the dual initial mode, and when the directions of the prediction modes of the two neighboring blocks respectively fall in different sections outside the coverage range, the prediction modes at the boundaries with the farthest distance are found from the prediction modes of four boundaries for replacement. Referring to (e) of FIG. 9, the prediction modes (directions 950 and 951) of the neighboring hocks are used to replace the prediction modes (directions 956 and 957) located at the boundaries of the coverage range and having the farthest distance.

The so-called farthest distance is a comparison result obtained based on distance calculation of the prediction modes. For example, if a distance between prediction modes A and B is to be calculated, the basic way is to calculate an absolute value of a subtraction of A and B, i.e. |A−B|. However, since the prediction mode has a fold back effect, it is required to be corrected. If |A−B|>16, the distance is (32−|A−B|) after a correction of reversing by 180 degrees. Therefore, a formal definition of a function Dist (A, B) of the distance between the prediction modes A and B is:

if (|A−B|>16)

Dist(A,B)=(32−|A−B|)

else

Dist(A,B)=|A−B|

wherein the prediction modes A and B are values of 2-34 and respectively represent prediction directions from the lower left to the upper right. For calculation conveniences, the reference numbers thereof are taken as a basis for calculation, and calculated values one-to-one correspond to directions of the prediction modes.

Taking a horizontal and vertical dual initial mode as an example, the four boundaries of the coverage range thereof are respectively modes 4, 16, 20 and 32, and if the prediction mode searched from the neighboring block on the top or to the left falls out of the coverage range, for example, the mode 33, the distances between the four boundaries and the mode 33 are:
Since |4−33|=29>16, Dist(4,33)=32−29=3;
Since |16−33|=17>16, Dist(16,33)=32−17=15;
Since |20−33|=13<16, Dist(20,33)=13
Since |32−33|=11<16, Dist(32,33)=1
   Therefore, the boundary farthest from the mode 33 is the mode 16 with the distance of 15.

The search method of the aforementioned embodiment includes the step S580 of adjusting the first-stage prediction modes with reference of a prediction mode searched from the neighboring block, though the disclosure is not limited thereto, and in another embodiment, the step S580 can be omitted.

In step S590, the coding cost calculator 470 calculates coding costs of the first-stage prediction modes and selects a prediction mode with the lowest coding cost, wherein the selected prediction mode is the prediction mode searched according to the search method of prediction mode having direction.

In summary, the disclosure provides an intra prediction method and an intra prediction unit and a search method and a search apparatus of prediction mode having direction, by which the initial prediction mode may be quickly selected based on the distribution of the directional energy values, or a fine adjustment can be processed according to the prediction mode of a coded neighboring block. Based on a method of spreading the prediction mode in two stages, by selecting suitable prediction modes, the number of the prediction modes requiring calculation of the coding cost may be reduced and descent coding quality may be maintained.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A search method performed in a search apparatus of prediction mode having direction, comprising:
obtaining a plurality of directional energy values of a plurality of directions specific to a block of a frame in a video;
selecting at least one initial prediction mode based on a distribution of the directional energy values;
obtaining a plurality of first-stage prediction modes by spreading out from the initial prediction mode; and
calculating coding costs of the first-stage prediction modes and selecting a prediction mode with the lowest coding cost.

2. The search method as claimed in claim 1, wherein the step of selecting the at least one initial prediction mode based on the distribution of the directional energy values comprises:
analyzing the distribution of the directional energy values for classification; and
selecting the initial prediction mode according to a classification result.

3. The search method as claimed in claim 2, wherein the step of analyzing the distribution of the directional energy values for classification comprises:
classifying the distribution of the directional energy values as a first distribution when differences among all of the directional energy values are less than a first threshold;
classifying the distribution of the directional energy values as a second distribution when differences between one of the directional energy values (corresponding to a first direction) and the remaining directional energy values are all greater than a second threshold, and a relationship between the directional energy value corresponding to the first direction and the remaining directional energy values indicates that a pixel value variation along the first direction in the block is less than those along directions corresponding to the remaining directional energy values in the block;
classifying the distribution of the directional energy values as a third distribution when a difference between two of the directional energy values (corresponding to a second direction and a third direction) is less than a third threshold, and differences between each of the two directional energy values and the other remaining directional energy values are all greater than a fourth threshold, and a relationship between the directional energy values corresponding to the second direction and the third direction and the remaining directional energy values indicates that pixel value variations along the second direction and the third direction in the block are less than those along directions corresponding to the remaining directional energy values in the block; and
classifying the distribution of the directional energy values as a fourth distribution when differences among three of the directional energy values (corresponding to a fourth direction, a fifth direction and a sixth direction) are all less than a fifth threshold, and differences between each of the three directional energy values and the other remaining directional energy values are all greater than a sixth threshold, and a relationship between the directional energy values corresponding to the fourth direction, the fifth direction and the sixth direction and the remaining directional energy values indicates that pixel value variations along the fourth direction, the fifth direction and the sixth direction in the block are less than pixel value variations along directions corresponding to the remaining directional energy values in the block.

4. The search method as claimed in claim 3, wherein the step of selecting the initial prediction mode according to the classification result comprises:
selecting a prediction mode of a central direction from all of the prediction modes having direction as the initial prediction mode when the distribution of the directional energy values is classified as the first distribution;
selecting a prediction mode of the first direction as the initial prediction mode when the distribution of the directional energy values is classified as the second distribution;
when the distribution of the directional energy values is classified as the third distribution:
when an angle between the second direction and the third direction is less than 90 degrees, selecting a prediction mode of a central direction between the second direction and the third direction as the initial prediction mode; and
when the angle between the second direction and the third direction is greater than 90 degrees, and one of the second direction and the third direction is reversed by 180 degrees to serve as a seventh direction, and a central direction between the seventh direction and the other one of the second direction and the third direction that is not reversed by 180 degrees falls within a range of the prediction modes, selecting the prediction mode of the central direction as the initial prediction mode;
when the central direction in the second direction and the third direction is one of the directions from which the directional energy values are obtained, using the prediction modes of the second direction and the third direction as the initial prediction mode; and
when the distribution of the directional energy values is classified as the fourth distribution, selecting a prediction mode of a central direction of the fourth direction, the fifth direction and the sixth direction as the initial prediction mode.

5. The search method as claimed in claim 4, wherein the step of obtaining the first-stage prediction modes by spreading out from the initial prediction mode comprises:
selecting prediction modes in N directions to be the first-stage prediction modes by equally spreading out from the initial prediction mode as a center towards the left and right with predetermined spaces when the number of the initial prediction modes is only one, wherein N is a positive integer greater than 1; and
selecting prediction modes in N/2 directions to be the first-stage prediction modes by equally spreading out from the initial prediction mode as the center towards the left and right with the predetermined spaces when the number of the initial prediction modes is two,
wherein when a spreading direction is out of a range of directions of all of the prediction modes, the spreading direction is reversed by 180 degrees for spreading.

6. The search method as claimed in claim 1 further comprising:
adjusting the first-stage prediction modes with reference of a prediction mode searched from a neighboring block of the block.

7. The search method as claimed in claim 6, wherein the step of adjusting the first-stage prediction modes with reference of the prediction mode searched from the neighboring block of the block comprises:
not to perform adjustments when the prediction mode searched from the neighboring block is a prediction mode not having directions;
not to perform adjustments when a direction of the prediction mode searched from the neighboring block is within a coverage range spread out from a direction of the initial prediction mode as a center; and
using the prediction mode searched from the neighboring block to replace a prediction mode located at a boundary of the coverage range and having a farthest distance when the direction of the prediction mode searched from the neighboring block is not within the coverage range.

8. A search method performed in a search apparatus of prediction mode having direction comprising:
obtaining a plurality of directional energy values of a plurality of directions specific to a block of a frame in a video;
selecting at least one initial prediction mode according to the directional energy values;
obtaining a plurality of first-stage prediction modes by spreading out from the initial prediction mode;
adjusting the first-stage prediction modes with reference of a prediction mode searched from a neighboring block of the block; and
calculating coding costs of the first-stage prediction modes and selecting a prediction mode with the lowest coding cost.

9. The search method of prediction mode having direction as claimed in claim 8, wherein the step of adjusting the first-stage prediction modes with reference of the prediction mode searched from the neighboring block of the block comprises:
not to perform adjustments when the prediction mode searched from the neighboring block is a prediction mode not having direction;
not to perform adjustments when a direction of the prediction mode searched from the neighboring block is within a coverage range spread out from a direction of the initial prediction mode as a center; and
using the prediction mode searched from the neighboring block to replace a prediction mode located at a boundary of the coverage range and having a farthest distance when the direction of the prediction mode searched from the neighboring block is not within the coverage range.

10. The search method as claimed in claim 8, wherein the step of selecting the at least one initial prediction mode according to the directional energy values comprises:
analyzing a distribution of the directional energy values for classification; and
selecting the initial prediction mode according to a classification result.

11. The search method as claimed in claim 10, wherein the step of analysing the distribution of the directional energy values for classification comprises:
classifying the distribution of the directional energy values as a first distribution when differences among all of the directional energy values are less than a first threshold;
classifying the distribution of the directional energy values as a second distribution when differences between one of the directional energy values (corresponding to a first direction) and the remaining directional energy values are all greater than a second threshold, and a relationship between the directional energy value corresponding to the first direction and the remaining directional energy values indicates that a pixel value variation along the first direction in the block is less than those along directions corresponding to the remaining directional energy values in the block;
classifying the distribution of the directional energy values as a third distribution when a difference between two of the directional energy values (corresponding to a second direction and a third direction) is less than a third threshold, and differences between each of the two directional energy values and the other remaining directional energy values are all greater than a fourth threshold, and a relationship between the directional energy values corresponding to the second direction and the third direction and the remaining directional energy values indicates that pixel value variations along the second direction and the third direction in the block are less than those along directions corresponding to the remaining directional energy values in the block; and
classifying the distribution of the directional energy values as a fourth distribution when differences among three of the directional energy values (corresponding to a fourth direction, a fifth direction and a sixth direction) are all less than a fifth threshold, and differences between each of the three directional energy values and the other remaining directional energy values are all greater than a sixth threshold, and a relationship between the directional energy values corresponding to the fourth direction, the fifth direction and the sixth direction and the remaining directional energy values indicates that pixel value variations along the fourth direction, the fifth direction and the sixth direction in the block are less than those along directions corresponding to the remaining directional energy values in the block.

12. The search method as claimed in claim 11, wherein the step of selecting the initial prediction mode according to the classification result comprises:
selecting a prediction mode of a central direction from all of the prediction modes having direction as the initial prediction mode when the distribution of the directional energy values is classified as the first distribution;
selecting a prediction mode of in the first direction as the initial prediction mode when the distribution of the directional energy values is classified as the second distribution;
when the distribution of the directional energy values is classified as the third distribution:
when an angle between the second direction and the third direction is less than 90 degrees, selecting a prediction mode of a central direction between the second direction and the third direction as the initial prediction mode; and
when the angle between the second direction and the third direction is greater than 90 degrees, and one of the second direction and the third direction is reversed by 180 degrees to serve as a seventh direction, and a central direction between the seventh direction and the other one of the second direction and the third direction that is not reversed by 180 degrees falls within a range of the prediction modes selecting the prediction mode in the central direction as the initial prediction mode;
when the central direction of the second direction and the third direction is one of the directions from which the directional energy values are obtained, using the prediction modes of the second direction and the third direction as the initial prediction mode; and
when the distribution of the directional energy values is classified as the fourth distribution, selecting a prediction mode of a central direction of the fourth direction, the fifth direction and the sixth direction as the initial prediction mode.

13. The search method as claimed in claim 12, wherein the step of obtaining the first-stage prediction modes by spreading from the initial prediction mode comprises:
selecting prediction modes in N directions to be the first-stage prediction modes by equally spreading out from the initial prediction mode as a center towards the left and right with predetermined spaces when the number of the initial prediction modes is only one, wherein N is a positive integer greater than 1; and
selecting prediction modes in N/2 directions to be the first-stage prediction modes by equally spreading out from the initial prediction mode as the center towards the left and right with the predetermined spaces when the number of the initial prediction modes is two,
wherein when a spread direction is out of a range of directions of all of the prediction modes, the spread direction is reversed by 180 degrees for spreading.

14. A search apparatus of prediction mode having direction, comprising:
a directional energy calculator for obtaining a plurality of directional energy values of a plurality of directions specific to a block of a frame in a video;
an analyzer for analyzing a distribution of the directional energy values for classification;
a selector, coupled to the analyzer, for selecting an initial prediction mode according to a classification result from the analyzer;
a spreader for obtaining a plurality of first-stage prediction modes by spreading from the initial prediction mode; and
a coding cost calculator for calculating coding costs of the first-stage prediction modes and selecting a prediction mode with the lowest coding cost.

15. The search apparatus of prediction mode having direction as claimed in claim 14, wherein the analyzer analyzes the distribution of the directional energy values:
classifying the distribution of the directional energy values as a first distribution when differences among all of the directional energy values are less than a first threshold;
classifying the distribution of the directional energy values as a second distribution when differences between one of the directional energy values (corresponding to a first direction) and the remaining directional energy values are all greater than a second threshold, and a relationship between the directional energy value corresponding to the first direction and the remaining directional energy values indicates that a pixel value variation along the first direction in the block is less than those along directions corresponding to the remaining directional energy values in the block;
classifying the distribution of the directional energy values as a third distribution when a difference between two of the directional energy values (corresponding to a second direction and a third direction) is less than a third threshold, and differences between each of the two directional energy values and the other remaining directional energy values are all greater than a fourth threshold, and a relationship between the directional energy values corresponding to the second direction and the third direction and the remaining directional energy values indicates that pixel value variations along the second direction and the third direction in the block are less than those along directions corresponding to the remaining directional energy values in the block; and
classifying the distribution of the directional energy values as a fourth distribution when differences among three of the directional energy values (corresponding to a fourth direction, a fifth direction and a sixth direction) are all less than a fifth threshold, and differences between each of the three directional energy values and the other remaining directional energy values are all greater than a sixth threshold, and a relationship between the directional energy values corresponding to the fourth direction, the fifth direction and the sixth direction and the remaining directional energy values indicates that pixel value variations along the fourth direction, the fifth direction and the sixth direction in the block are less than those along directions corresponding to the remaining directional energy values in the block.

16. The search apparatus of prediction mode having direction as claimed in claim 15, wherein the selector determines the classification result from the analyzer:
selecting a prediction mode of a central direction from all of the prediction modes having direction as the initial prediction mode when the distribution of the directional energy values is classified as the first distribution;
selecting a prediction mode of the first direction as the initial prediction mode when the distribution of the directional energy values is classified as the second distribution;
when the distribution of the directional energy values is classified as the third distribution:
when an angle between the second direction and the third direction is less than 90 degrees, selecting a prediction mode in a central direction between the second direction and the third direction as the initial prediction mode; and
when the angle between the second direction and the third direction is greater than 90 degrees, and one of the second direction and the third direction is reversed by 180 degrees to serve as a seventh direction, and a central direction between the seventh direction and another one of the second direction and the third direction that is not reversed by 180 degrees falls within a range of the prediction modes, selecting the prediction mode in a central direction as the initial prediction mode;
when the central direction of the second direction and the third direction is one of the directions from which the directional energy values are obtained, using the prediction modes of the second direction and the third direction as the initial prediction mode; and
when the distribution of the directional energy values is classified as the fourth distribution, selecting a prediction mode of a central direction of the fourth direction, the fifth direction and the sixth direction as the initial prediction mode.

17. The search apparatus of prediction mode having direction as claimed in claim 16, wherein the spreader determines the initial prediction mode:
selecting prediction modes in N directions to be the first-stage prediction modes by equally spreading out from the initial prediction mode as a center towards the left and right with predetermined spaces when the number of the initial prediction modes is only one, wherein N is a positive integer greater than 1; and
selecting prediction modes in N/2 directions to be the first-stage prediction modes by equally spreading out from the initial prediction mode as the center towards the left and right with the predetermined space when the number of the initial prediction modes is two,
wherein when a spreading direction is out of a range of directions of all of the prediction modes, the spreading direction is reversed by 180 degrees for spreading.

18. A search apparatus of prediction mode having direction, comprising:
a directional energy calculator for obtaining a plurality of directional energy values of a plurality of directions specific to a block of a frame in a video;
an initial prediction mode selector for selecting at least one initial prediction mode according to the directional energy values;
a spreader for obtaining a plurality of first-stage prediction modes by spreading out from the initial prediction mode;
an adjustor for adjusting the first-stage prediction modes with reference of a prediction mode searched from a neighboring block of the block; and
a coding cost calculator for calculating coding costs of the first-stage prediction modes and selecting a prediction mode with the lowest coding cost.

19. The search apparatus of prediction mode having direction as claimed in claim 18, wherein the adjuster determines the prediction mode searched from the neighboring block:
not performing adjustments when the prediction mode searched from the neighboring block is a prediction mode not having direction;
not performing adjustments when a direction of the prediction mode searched from the neighboring block is within a coverage range spread out from a direction of the initial prediction mode as a center; and
using the prediction mode searched from the neighboring block to replace a prediction mode located at a boundary of the coverage range and having a farthest distance when the direction of the prediction mode searched from the neighboring block is not within the coverage range.

20. The search apparatus of prediction mode having direction as claimed in claim 18, wherein the initial prediction mode selector comprises:
an analyzer for analyzing a distribution of the directional energy values for classification; and
a selector, coupled to the analyzer, for selecting the initial prediction mode according to a classification result.

21. The search apparatus of prediction mode having direction as claimed in claim 20, wherein the analyzer analyzes the distribution of the directional energy values:
classifying the distribution of the directional energy values as a first distribution when differences among all of the directional energy values are less than a first threshold;
classifying the distribution of the directional energy values as a second distribution when differences between one of the directional energy values (corresponding to a first direction) and the remaining directional energy values are all greater than a second threshold, and a relationship between the directional energy value corresponding to the first direction and the remaining directional energy values indicates that a pixel value variation along the first direction in the block is less than those along directions corresponding to the remaining directional energy values in the block;
classifying the distribution of the directional energy values as a third distribution when a difference between two of the directional energy values (corresponding to a second direction and a third direction) is less than a third threshold, and differences between each of the two directional energy values and the other remaining directional energy values are all greater than a fourth threshold, and a relationship between the directional energy values corresponding to the second direction and the third direction and the remaining directional energy values indicates that pixel value variations along the second direction and the third direction in the block are less than those along directions corresponding to the remaining directional energy values in the block; and
classifying the distribution of the directional energy values as a fourth distribution when differences among three of the directional energy values (corresponding to a fourth direction, a fifth direction and a sixth direction) are all less than a fifth threshold, and differences between each of the three directional energy values and the other remaining directional energy values are all greater than a sixth threshold, and a relationship between the directional energy values corresponding to the fourth direction, the fifth direction and the sixth direction and the remaining directional energy values indicates that pixel value variations along the fourth direction, the fifth direction and the sixth direction in the block are less than those along directions corresponding to the remaining directional energy values in the block.

22. The search apparatus of prediction mode having direction as claimed in claim 21, wherein the selector determines the classification result from the analyzer:
selecting a prediction mode of a central direction from all of the prediction modes having direction as the initial prediction mode when the distribution of the directional energy values is classified the first distribution;
selecting a prediction mode of the first direction as the initial prediction mode when the distribution of the directional energy values is classified as the second distribution;
when the distribution of the directional energy values is classified as the third distribution:
when an angle between the second direction and the third direction is less than 90 degrees, selecting a prediction mode in a central direction between the second direction and the third direction as the initial prediction mode; and
when the angle between the second direction and the third direction is greater than 90 degrees, and one of the second direction and the third direction is reversed by 180 degrees to serve as a seventh direction, and the central direction between the seventh direction and another one of the second direction and the third direction that is not reversed by 180 degrees falls within a range of the prediction modes, selecting the prediction mode in a central direction as the initial prediction mode;
when the central direction in the second direction and the third direction is one of the directions from which the directional energy values are obtained, using the prediction modes in the second direction and the third direction as the initial prediction mode; and
when the distribution of the directional energy values is classified as the fourth distribution, selecting a prediction mode of a central direction of the fourth direction, the fifth direction and the sixth direction as the initial prediction mode.

23. The search apparatus of prediction mode having direction as claimed in claim 22, wherein the spreader determines the initial prediction mode:
selecting prediction modes in N directions to be the first-stage prediction modes by equally spreading out from the initial prediction mode as a center towards the left and right with predetermined spaces when the number of the initial prediction modes is only one, wherein N is a positive integer greater than 1; and
selecting prediction modes in N/2 directions to be the first-stage prediction modes by equally spreading out from the initial prediction mode as the center towards the left and right with the predetermined spaces when the number of the initial prediction modes is two,
wherein when a spread direction is out of a range of directions of all of the prediction modes, the spread direction is reversed by 180 degrees for spreading.
